(19) United States
(12) Patent Application Publication
(10) Pub. No.: US 2021/0366032 A1
(43) Pub. Date: Nov. 25, 2021

(54) Virtual Shopping/Gaming Experience

(71) Applicant: INVNT LLC, New York, NY (US)

(72) Inventor: Scott Cullather, New york, NY (US)

(73) Assignee: INVNT LLC, New York, NY (US)

(21) Appl. No.: 17/211,526

(22) Filed: Mar. 24, 2021

Related U.S. Application Data
(60) Provisional application No. 63/027,179, filed on May 19, 2020.

(51) Int. Cl. G06Q 30/06; G06Q 20/10; A63F 13/69; A63F 13/822

(52) U.S. Cl. CPC G06Q 30/0643; G06Q 30/0633; G06Q 30/0621; A63F 2300/5553; A63F 13/69; A63F 13/822; G06Q 20/102

(57) ABSTRACT

Combined online game and e-commerce systems and methods are provided. The systems and methods provide an online gaming and shopping experience for the gamer in which the gamer may play various aspects of the game wherein at least one of the aspects of the game is a store or group of stores that offer the option to purchase items and/or services for receipt in the physical world.

### CROSS REFERENCE TO RELATED APPLICATIONS

This application claims the benefit of the filing date of U.S. provisional patent application No. 63/027,179 entitled “Virtual Shopping/Gaming Experience”, which was filed on May 19, 2020, by the same inventor as this application. That provisional application is hereby incorporated by reference as if fully set forth herein.

### FIELD OF THE TECHNOLOGY

One or more embodiments of the disclosed technology relate(s) generally to online shopping and gaming and more specifically but not exclusively to a combined ecommerce and gaming platform.

### BACKGROUND OF THE TECHNOLOGY

Massively multiplayer online role-playing games (“mmorpg”) are very popular and generate a lot of revenue. In fact, gamers spend many hours each day playing such games. Most gamers are in their twenties and thirties and have jobs/careers. As such, these gamers are also consumers, however, when they are gaming, they are not utilizing their purchasing power on real-world purchases.

E-commerce (online shopping) is also very popular and generates billions of dollars in revenue each year. Some companies have attempted to create a virtual shopping experience by creating 2-D and 3-D online shopping malls, however, this technology has yet to gain traction as there is no incentive for people to use this technology when it merely adds another layer of complication to the online shopping experience.

It would thus be advantageous to provide an online shopping experience that combines with an online gaming experience.

### BRIEF SUMMARY OF THE TECHNOLOGY

Many advantages will be determined and are attained by one or more embodiments of the disclosed technology, which in a broad sense provides a combination mmorpg and e-commerce platform, in which players engage in both role play and real-world shopping.

In one or more embodiments, a virtual mall is incorporated into a mmorpg or some other digital game. A consumer/gamer may enter the virtual mall while in the game and make real-time purchases. The virtual mall may offer stores with real-world items/services as well as stores for in-game purchases. The gamer may have an avatar and that avatar may interact with other avatars. In one or more embodiments, the mall may be customizable to each player or to groups of players and the items of purchase may be customizable. In one or more embodiments, the mall and/or a store may provide a shopping assistant and the item for purchase may be virtually tested (e.g. on an avatar or based on a photo/video of the person. If the item is for something other than the person it may be illustrated in a real-world environment—such as placing furniture in a room, paint for a house, etc.). In one or more embodiments, there may be hidden items/worlds/rooms which allow the gamer/consumer to purchase or win real-world items/prizes (e.g. concert tickets, encounters with a famous person, etc.).

In one or more embodiments, an improved e-commerce system is provided which may include a game that is accessible via a network. The game may include a representation of at least one physical world store, wherein the at least one store offers at least one product or service to purchase from within the game. A purchase of a product from the store results in both the product being purchased and the ownership of the product being transferred in the physical world. A purchase of a service from the store results in the service being performed in the real-world.

In one or more embodiments, a method is provided for making physical world purchases within an online game. The method may include providing a set of virtual stores within the online game, wherein the set of virtual stores is selectable by a gamer. The method may further include offering at least one product or service for purchase within at least one of the virtual stores and providing the product or service in the physical world in response to the gamer making a purchase in the virtual store within the game.

In one or more embodiments, a non-transitory computer-readable medium is provided which may include one or more computer-executable instructions that, when executed by at least one processor of a computing device, may cause the computing device to connect to a game via a network. The instructions may further cause the computing device to receive input to enter a virtual store within the game and make a purchase within the game that is effective in the physical world. The instructions may further cause the computing device to deliver payment for the purchase within the game.

### BRIEF DESCRIPTION OF THE DRAWINGS

For a better understanding of the invention, reference is made to the following description, taken in conjunction with the accompanying drawings, in which like reference characters refer to like parts throughout, and in which:

FIG. 1 provides a block diagram illustrating an exemplary combined online game and ecommerce system in accordance with one or more aspects of the described technology;

FIG. 2 illustrates a block diagram providing elements present in the devices in the system of FIG. 1;

FIG. 3 is a flowchart illustrating an exemplary method for traversing the combined online game and ecommerce system in accordance with one or more aspects of the described technology;

FIG. 4 is a flowchart continuing from the flowchart of FIG. 3 illustrating an exemplary method for playing a game within the online game in accordance with one or more aspects of the described technology;

FIG. 5 provides a flowchart continuing from the flowchart of FIG. 3 illustrating an exemplary method for shopping for goods within the online game in accordance with one or more aspects of the described technology;

FIG. 6 provides a flowchart continuing from the flowchart of FIG. 3 illustrating an exemplary method for shopping for services within the online game in accordance with one or more aspects of the described technology;

FIG. 7 provides a flowchart continuing from the flowchart of FIG. 3 illustrating an exemplary method for creating a store within the online game in accordance with one or more aspects of the described technology;

FIG. 8 provides a flowchart continuing from the flowchart of FIG. 3 illustrating an exemplary method for creating and/or attending an event within the online game in accordance with one or more aspects of the described technology;

FIG. 9 provides a flowchart continuing from the flowchart of FIG. 3 illustrating an exemplary method for interacting with other gamers within the online game in accordance with one or more aspects of the described technology;

FIG. 10 provides a flowchart continuing from the flowchart of FIG. 3 illustrating an exemplary method for creating and/or modifying an avatar within the online game in accordance with one or more aspects of the described technology;

FIG. 11 provides a flowchart continuing from the flowchart of FIG. 3 illustrating an exemplary method for creating or modifying a mall within the online game in accordance with one or more aspects of the described technology;

FIG. 12 illustrates an exemplary mall showing an external view within the online game in accordance with one or more aspects of the described technology;

FIG. 13 illustrates an exemplary common area within the online game in accordance with one or more aspects of the described technology;

FIG. 14 illustrates an exemplary screen for creating and customizing an avatar within the online game in accordance with one or more aspects of the described technology;

FIG. 15 illustrates an exemplary personal shopper avatar within the online game in accordance with one or more aspects of the described technology;

FIG. 16 illustrates an exemplary shopping experience within the online game in accordance with one or more aspects of the described technology;

FIG. 17 illustrates an exemplary payment method within the online game in accordance with one or more aspects of the described technology;

FIG. 18 illustrates an exemplary passageway for entering a venue within the online game in accordance with one or more aspects of the described technology;

FIG. 19 illustrates attendance at an event within the online game in accordance with one or more aspects of the described technology;

FIG. 20 illustrates an exemplary event shopping experience within the online game in accordance with one or more aspects of the described technology;

FIG. 21 provides an exemplary entrance to a live concert venue within the online game in accordance with one or more aspects of the described technology; and,

FIG. 22 provides an exemplary wireframe of the online game in accordance with one or more aspects of the described technology.

The technology will next be described in connection with certain illustrated embodiments and practices. However, it will be clear to those skilled in the art that various modifications, additions, and subtractions can be made without departing from the spirit or scope of the claims.

### DETAILED DESCRIPTION OF THE TECHNOLOGY

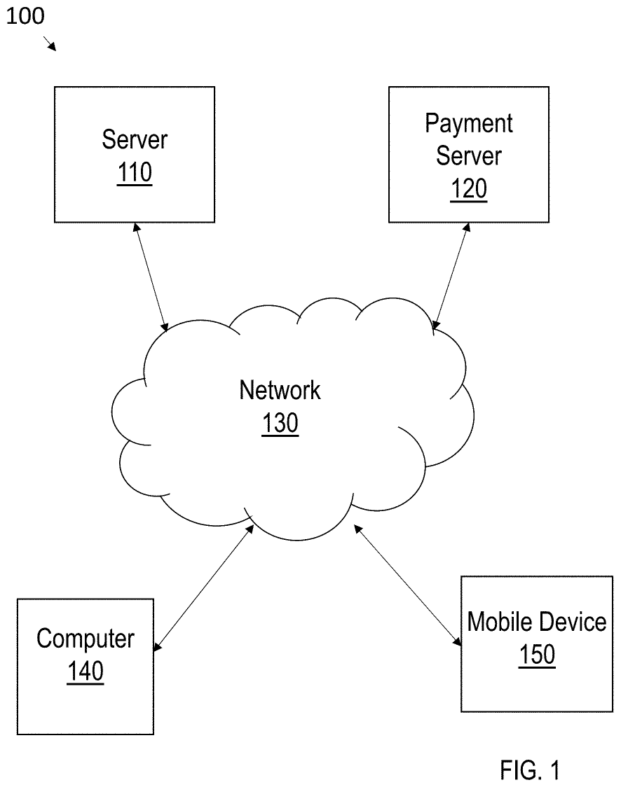

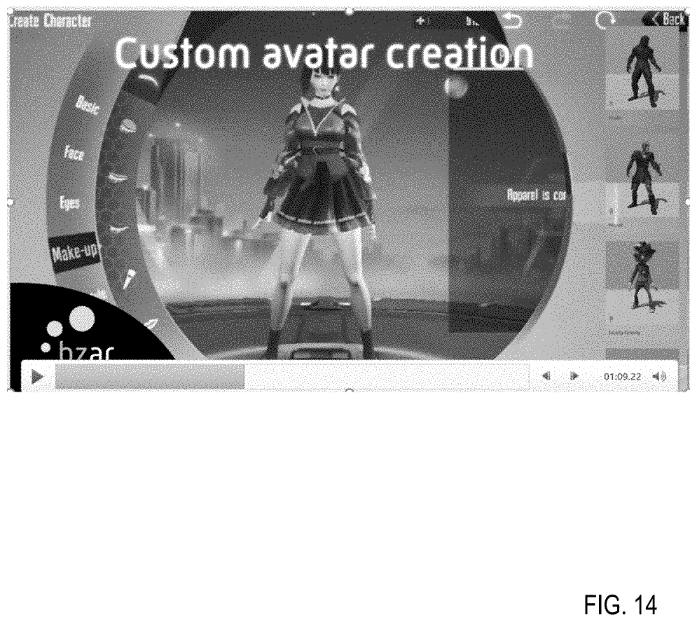

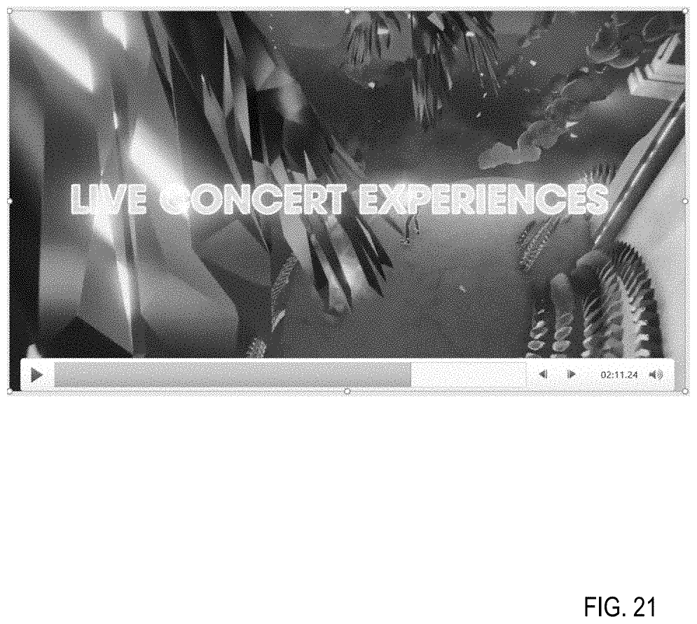

Referring to the figures in detail wherein like reference numerals identify like elements throughout the various figures, there is illustrated in FIGS. 1-21 systems and methods for providing gamers with an opportunity to make real-world purchases within an online game. The experience of shopping with friends may be recreated in an online gaming environment. Gamers may have the option to visit a mall and make real-world and/or in-game purchases while playing the game. The mall may include pop-up stores/kiosks and may provide access to events such as concerts, sporting events, shows, conferences, and the like. These events may be attended in the physical world and/or they may be displayed within the game. The experience of shopping may be similar to the physical world experience in that gamers may virtually walk the mall with their friends, they can ask their friends for advice with their purchases, etc. Additionally, or alternatively, gamers or other participants may be provided the opportunity to create their own store(s), mall(s), in-game event(s), real-world event(s) and/or a combination in-game/real-world event(s). There may be default skins for any/all of the above items from which a gamer may choose and/or there may be skins for purchase, gifting or trade. Skins may be won, earned or found.

The following description is provided as an enabling teaching as it is best, currently known. To this end, those skilled in the relevant art will recognize and appreciate that many changes can be made to the various aspects described herein, while still obtaining the beneficial results of the technology disclosed. It will also be apparent that some of the desired benefits can be obtained by selecting some of the features while not utilizing others. Accordingly, those with ordinary skill in the art will recognize that many modifications and adaptations are possible, and may even be desirable in certain circumstances, and are a part of the technology described. Thus, the following description is provided as illustrative of the principles of the technology and not in limitation thereof.

Discussion of an embodiment, one or more embodiments, an aspect, one or more aspects, a feature, one or more features, or a configuration or one or more configurations is intended to be inclusive of both the singular and the plural depending upon which provides the broadest scope without running afoul of the existing art and any such statement is in no way intended to be limiting in nature. Technology described in relation to one or more of these terms is not necessarily limited to use in that particular embodiment, aspect, feature or configuration and may be employed with other embodiments, aspects, features and/or configurations where appropriate. Additionally, the use of the singular and the use of the plural regarding an element description is intended to be inclusive of both the singular and the plural depending upon which provides the broadest scope without running afoul of the existing art.

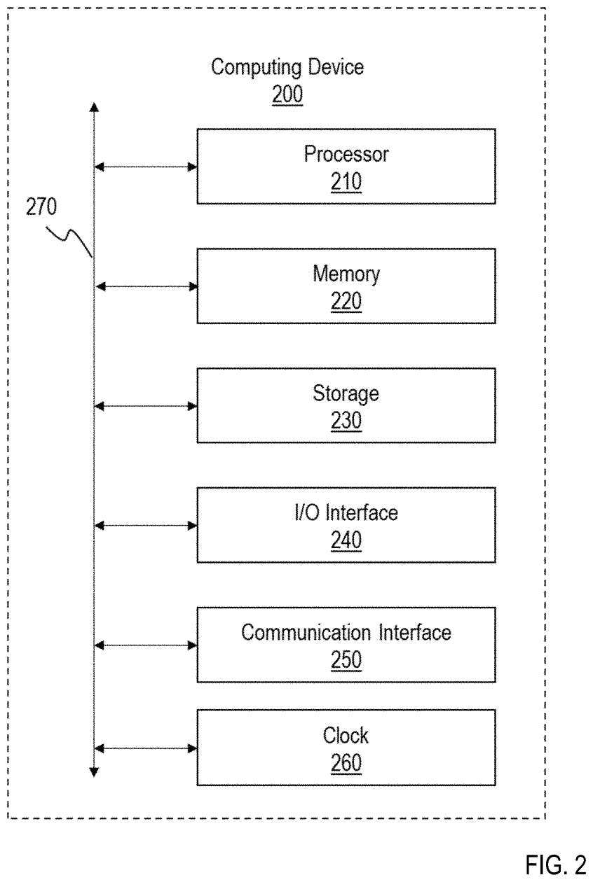

As illustrated in FIG. 1 the system 100 may include a server 110 which manages game play and ecommerce transactions, a payment server 120 which is used to process purchases made within a game, a mobile device 150 capable of connecting to the server 110 used to play a game and make purchases within the game and a computer 140 capable of connecting to the server 110 used to play a game and make purchases within the game. All of the various elements of the system 100 may communicate via network 130. While a single server 110, payment server 120, network 130, computer 140 and mobile device 150 are illustrated, that is merely for illustrative purposes only. Those skilled in the art will recognize that the system 100 could and probably would include multiple instances of each, but for ease of explanation the following description only refers to the single instances depicted in FIG. 1. As illustrated in FIG. 2, each of the devices 110/120/140/150 may be implemented in any suitable computing system or group of computing systems to implement the techniques and methods disclosed herein. FIG. 2 is a block diagram depicting examples of implementations of such components. The computing device 200 may include a processor 210 that is communicatively coupled to a memory 220 and that executes computer-executable program code and/or accesses information stored in memory 220 or storage 230. The processor 210 may include a microprocessor, an application-specific integrated circuit (“ASIC”), a state machine, or other processing device. The processor 210 can include one processing device or more than one processing device. Such a processor 210 can include or may be in communication with a computer-readable medium, which stores instructions that, when executed by the processor 210, cause the processor to perform the operations described herein.

The memory 220 and storage 230 may include any suitable non-transitory computer-readable medium. The computer-readable medium may include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript. In a preferred embodiment, the programming code for the game/ecommerce system is written in C++ on the Unreal Engine platform, however other programming languages and other platforms may be employed without departing from a scope of one or more claims.

The computing device 200 may also include external or internal devices such as input or output devices. For example, the computing device is shown with an input/output (“I/O”) interface 240 that can receive input from input devices or provide output to output devices. A communication interface 250 may also be included in the computing device 200 and may include any device or group of devices suitable for establishing a wired or wireless data connection to one or more data networks. Non-limiting examples of the communication interface 250 include an Ethernet network adapter, a modem, and/or the like. The computing device 200 can transmit messages as electronic or optical signals via the communication interface 250. The clock 260 is configured to identify time stamps for events. A bus 270 can also be included to communicatively couple one or more components of the computing device 200.

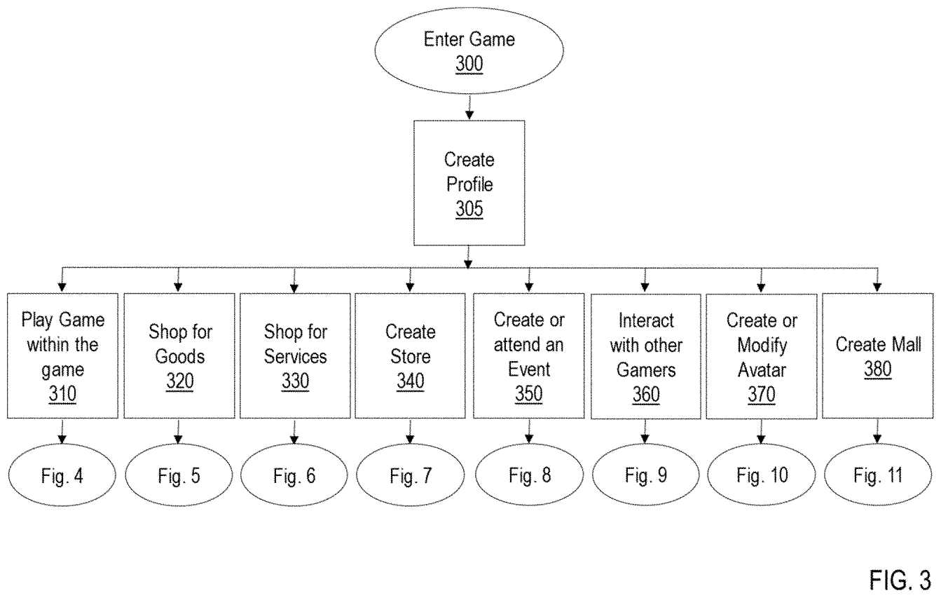

The computing device 200 can execute program code that configures the processor 210 to perform one or more of the operations described herein. The program code can include one or more modules. The program code may be resident in the memory 220, storage 230, or any suitable computer-readable medium and may be executed by the processor 210 or any other suitable processor. In one or more embodiments, modules can be resident in the memory 220. In additional or alternative embodiments, one or more modules can be resident in a memory that is accessible via a data network, such as a memory accessible to a cloud service. A game 300 (FIG. 3) may take the form of an application on a mobile device 150 and/or it may be a website that a user accesses via the Internet 130 or some other network 130 and/or it may be a program that resides on the user's device 140/150 and/or portions of the program may be resident on the user's device 140/150 while other portions may reside on the server 110. For ease of description, the remainder of the disclosure will focus on a consumer using a mobile device 150, but those skilled in the art will recognize that the description is easily applied to computer 140. The server(s) 110 and 120 may store (temporarily or permanently) information such as user profiles, information about purchases, information about purchasing trends, and/or any other conventional information that is stored on such servers. The storage of information and the type of information stored presently exists and thus the process or storage and the information stored will not be further examined. Most mobile devices include a camera (not illustrated) which may be used for one or more features of the disclosed technology.

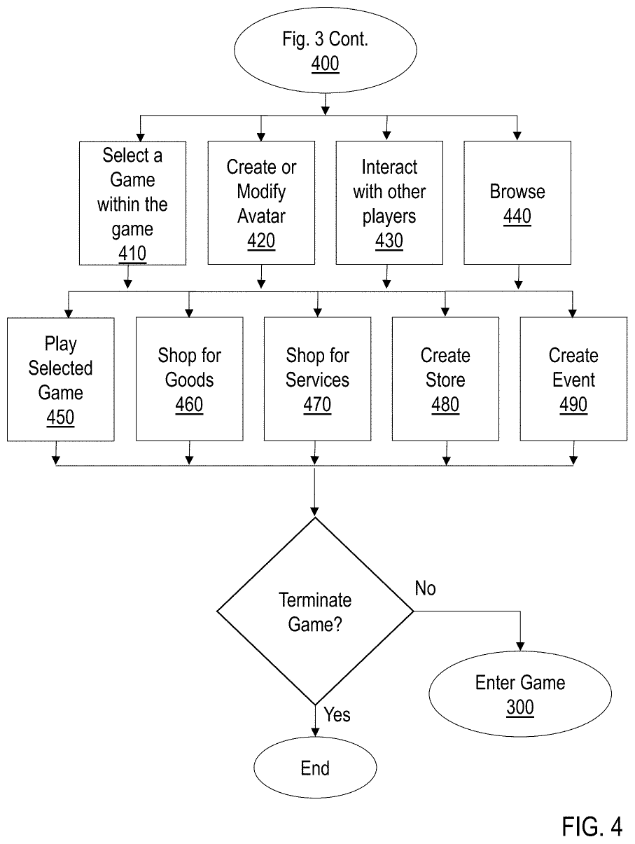

Turning to FIG.3, which alone and together with FIGS. 4-11 and 22, shows a logical flow diagram and not necessarily a sequential order of operation, the first time a user enters a game 300 or prior to actually entering a game 300 the user may be required to create a profile 305 or setup their account. In one or more embodiments, a user may skip this step and enter the game 300 as a guest with limited capabilities and a default guest profile and default avatar so the user can sample the game 300 before deciding whether or not to join. Setting up a profile 305 may include entering conventional information such as username, password, actual name, address, age, date of birth, phone number, payment information, loyalty numbers and/or any other information deemed required by the game 300.

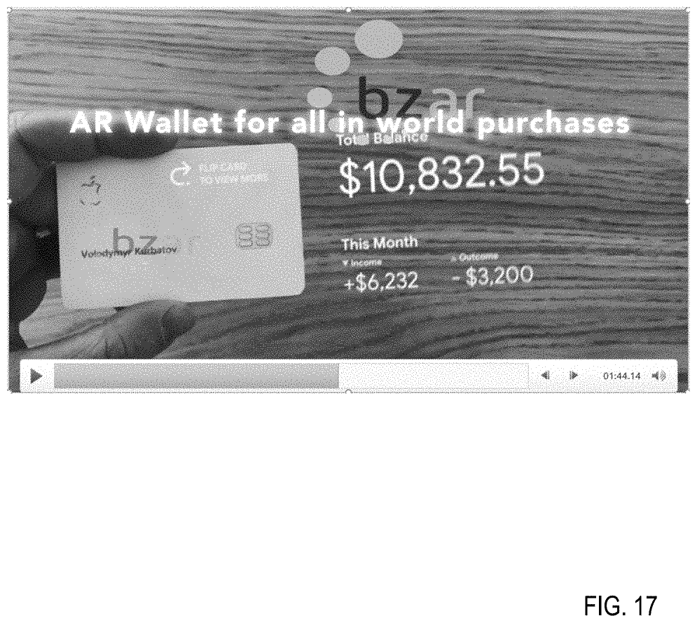

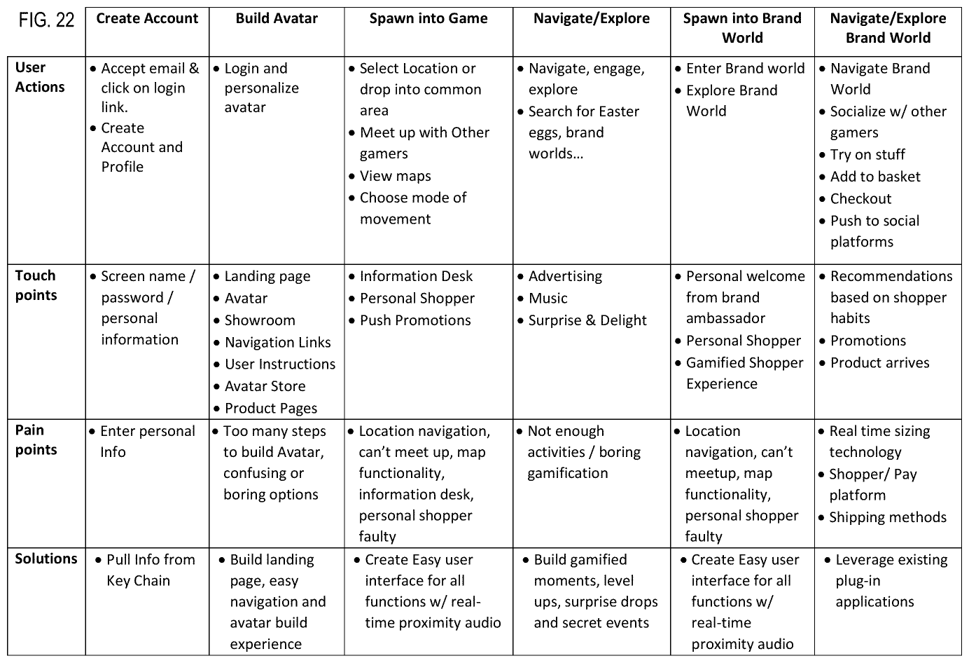

While creating a profile or at a later point in time (e.g. when entering a store, when making a purchase, in response to an advertisement, a user may be provided with an option to apply for an in-game payment system (e.g. FIGS. 17 and 22). The in-game payment system may be tied to the user's gaming account and personal credit cards or other payment accounts and may be required for making in-game purchases or may simply be an option. As with other payment systems, the in-game payment system may provide loyalty points or cash back based at least in part on whether the purchase is for in-game purchases or real-world purchases. The in-game payment system may track a user's purchases and offer directed advertisements, directed coupons or other targeted discounts and/or rewards based on the user's purchases and/or game profile. The in-game payment system may be used to make in-game purchases for use within the game and/or in-game purchases for use in the real-world.

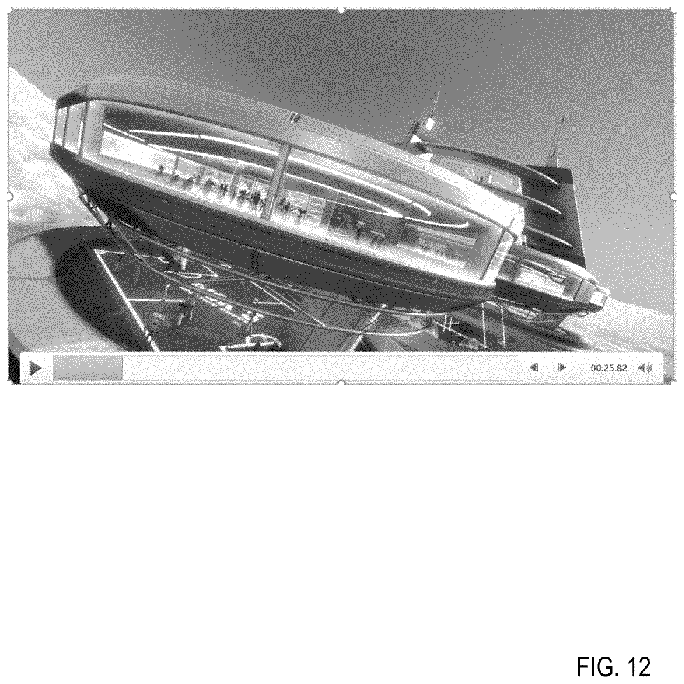

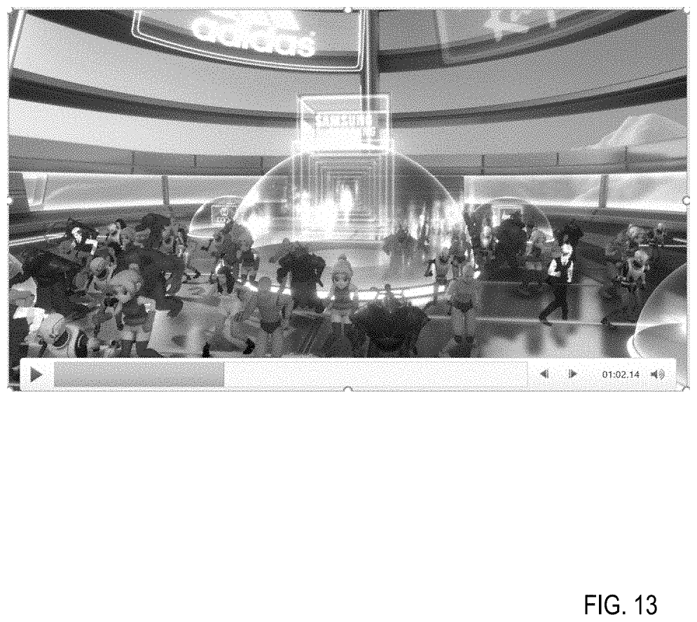

Once the user creates a profile 305, the user may be entered into a common area 120/130 of the game such as that illustrated in FIGS. 12 and 13. In one or more embodiments, after the first time entering the game 300, the user may be entered into the same location where the user left the game 300 or the user may have setup a specific location to enter (e.g. at a concert venue, in a store, etc.) or the user may be entering a location by invitation from another player or from a merchant. In one or more embodiments, a user may traverse the common areas by walking, running, entering a vehicle, or flying depending on the design choices of the system. One or more of these modes of transport may be provided by default and one or more of these modes of transport may require purchase, be earned and/or awarded in a contest or promotion, and/or be traded from another gamer. While in a common area, the gamer may have the option for music to be playing and to select from various songs and//or genres and/or stations. Some some/genres/stations may require purchase. While in a store or other venue the music may be selected by the merchant but is not required to be.

As illustrated in FIGS. 3 and 22, when the user enters the game there may be various options available such as play a game within the game 310, shop for goods (for real world and/or in game use) 320, shop for services (for real world and/or in game use) 330, create a store (to sell goods and/or services) 340, create and/or attend an event (such as a concert, a sporting event, a movie release, a show, a conference or any other event that can be attended either in real-life or in the game) 350, Interact with other gamers 360, create and/or customize an avatar 370 or create a custom mall 380.

As illustrated in FIG. 4, a user may be provided the option to play a game within the game 400. This game within the game 400 may be a game of skill, of luck and/or a game of chance (such as would exist in a casino). The game 400 may be a game against one or more other users, it may be a game between teams of users and the game may require prequalification, preregistration and/or an entrance fee or a time fee. When an entrance fee is required, in one or more embodiments the fee may be paid using the in-game payment system and/or via any payment system allowed. The game 400 may be an old-style video game such as Pong™ or it may be as advanced as Call of Duty®. While playing the game-in-game 400, the user may be provided with the same or similar options as within the main game 300. For example, the user may be able to create or modify their avatar 420 or they may be able to create and customize a temporary avatar 420 just for the game-in-game 400. It is also possible that a default avatar will be provided for the game-in-game 400 or that the game-in-game 400 will not utilize an avatar. While the main game 300 is preferably, but not required to be played in 3-D, the game-in-game may also be 2 dimensional or 3 dimensional. The user may also interact with other users 430 within the game-in-game 400, may just browse the game-in-game options 440, may shop for goods 460, shop for services 470, create a store 480 and/or create and/or attend an event 490. When leaving the game-in-game 400, the user may be provided the option to exit the main game 300 as well in which case the user will also exit the main game 300, or the user may simply return to the main game 300. In one or more embodiments, the user may enter an arcade within the common area or within a specific mall that provides a selection of games 400 within the main game 300.

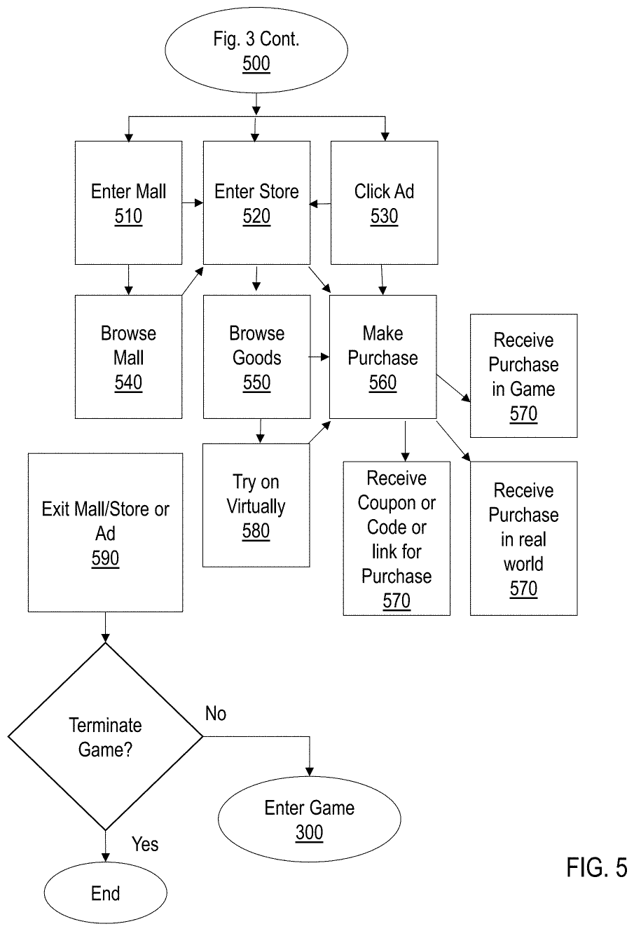

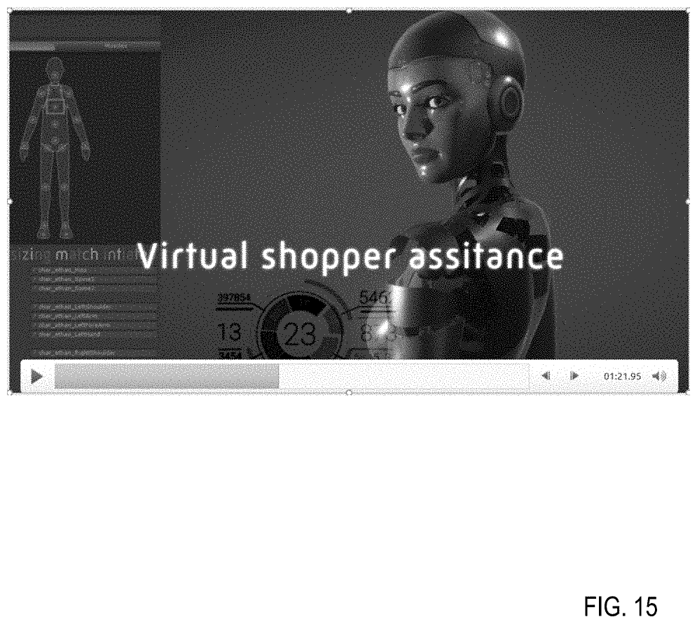

As illustrated in FIG. 5 and FIG. 22, one or more embodiments of the technology may provide the ability to shop for and purchase goods that can be used in the game 300 or in the real world. While traversing the game 300, the user may enter the mall 510, come across billboard advertisements 530, other forms of advertisements 530, stores 520 and/or kiosks 520. The user may browse the mall 540 to find a store 520 in which the user wishes to shop or may click or otherwise select an advertisement. The user's avatar may enter the store 520 manually or via the advertisement and then browse the goods 550 that are offered for sale within the store. In one or more embodiments, when the user selects an advertisement, the user may be presented with one or more products to purchase without entering a store. All other aspects of purchasing through an advertisement may be the same as purchasing through a store within the game. As illustrated in FIG. 15, or more stores may offer one or more shopping assistant avatars to assist with questions. Similar to many real-world stores, a retailer may have several shopper assistants who have their own Avatar and identity available to answer questions in real-time through the voice activated software guiding shoppers to the various items.

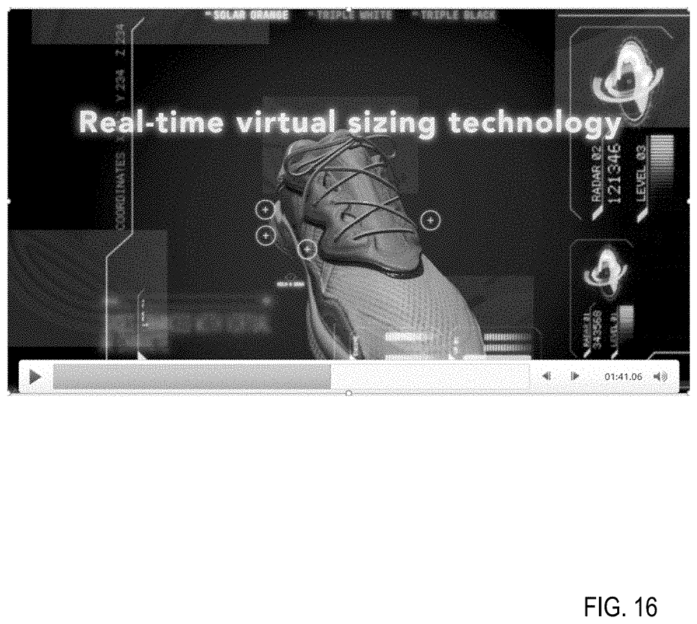

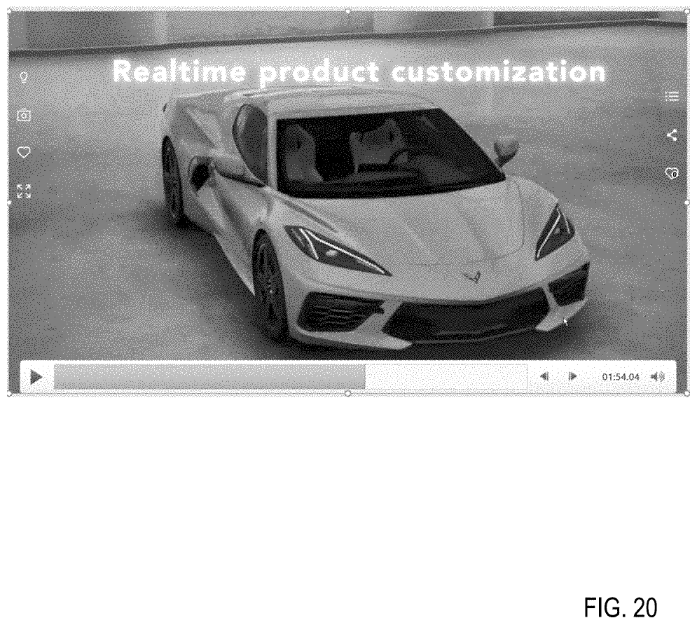

The goods in the store may be presented as a menu, as computer generated images and/or they may be actual images of the goods for sale. As illustrated in FIGS. 16 and 20, once a user selects an item that item may be customized for the user (e.g. the user may select the color, size, options, etc.). For example, if the user is purchasing furniture, alternate reality (AR) technology may allow the user to select a piece of furniture and see how that furniture would look in their home and/or other real-world environments. In one or more embodiments, the shopper may scan a barcode of a product (or select the product in another manner) which may transfer that product to the user's mobile device 150. The product can then be placed in a real-world environment through AR technology.

If the user is purchasing clothing, the user may try on the clothing 580 using AR technology. This would allow the user to select any item of clothing and try it on 580 enabling the user to see themselves in the products before purchasing them. This may apply to both virtual Avatar skins and actual merchandise that is purchased. In essence replicating a dressing room experience in a real/physical-world retail store.

Once a user selects an item for purchase, that item may be placed within a virtual shopping cart. In one or more embodiments, the user's shopping cart may remain in the store in which the user is shopping. I in one or more embodiments, the shopping cart may follow the user throughout the game 300 until the user is ready to checkout 560. The shopping cart may be a virtual depiction of a shopping cart filled with the products to be purchased and/or it could be a conventional online shopping cart. Once the user decides to checkout, the selected items are paid for using a selected payment method. When using the in-game payment system, the in-game payment system may contact the various stores from which items were purchased and arrange payment via the payment server. Real-world items that have been purchased may be shipped to an address of the user's selection 570, or the user may be provided a coupon or electronic code 570 to bring to a store for in-store pickup. When leaving the store or the mall, the user may be provided the option to exit the main game 300 as well in which case the user will also exit the main game 300, otherwise the user may simply return to the main game 300.

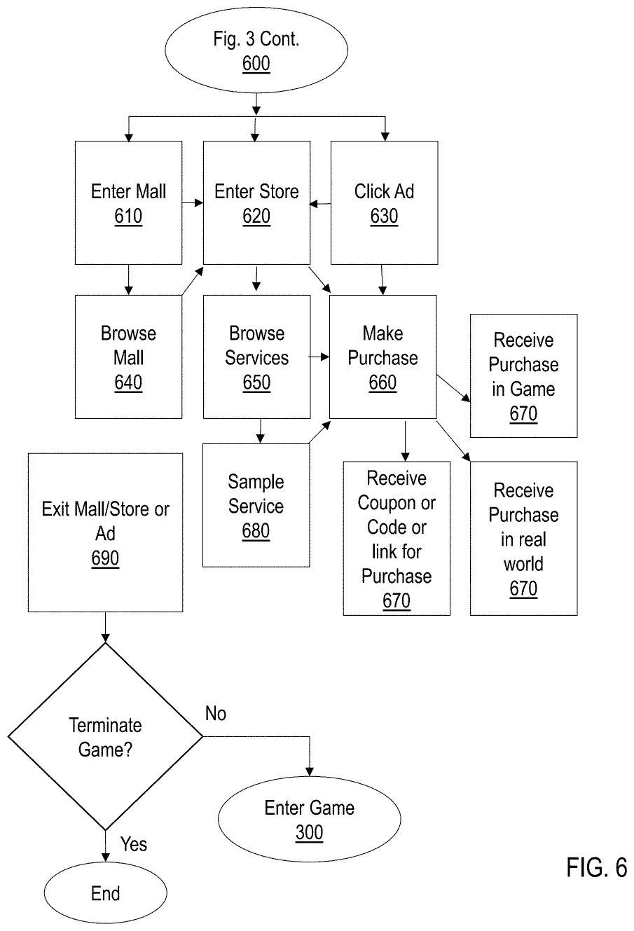

As illustrated in FIG. 6 and FIG. 22, one or more embodiments of the technology may provide the ability to shop for and purchase services (e.g. legal services, accounting services, hiring mercenaries for a game, recruiting for a game-in-game, coaching services, or virtually any other type of service, that can be used in the game 300 or in the real-world. The method of purchase is similar to those described in relation to the purchase of goods. A difference may be that rather than virtually trying on goods, the user may be provided a sample of the service prior to purchase.

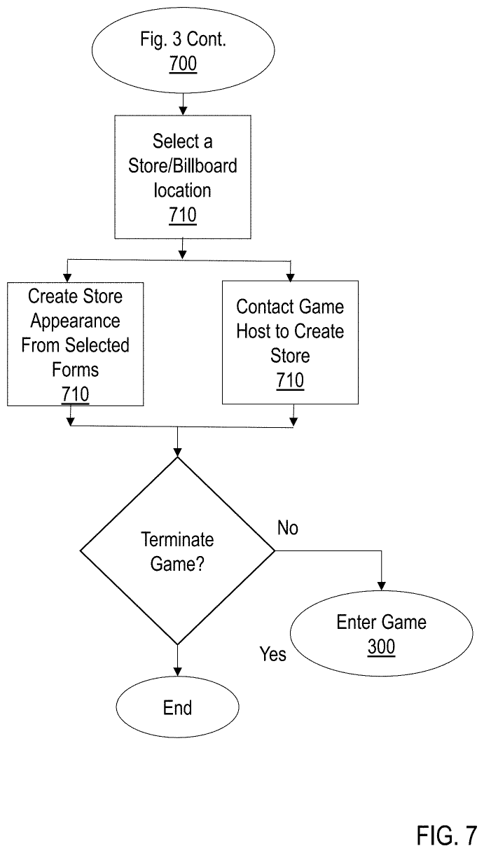

As illustrated in FIG. 7 and FIG. 22, one or more embodiments of the technology may provide the ability to create a store 700 for selling goods and/or services. A user may be provided the option to select a billboard and/or a kiosk 710 within a common area and customize various aspects of the advertisement or kiosk with various predefined options. Alternatively, the user may contact the game host and have the game host create the advertisement or kiosk to the user's specifications (e.g. the user may provide graphics and or advertisements and/or videos and/or other features that the host incorporates into the game, and/or the host may generate one or more aspects of the advertisement and/or kiosk based on user input). In one or more embodiments, a store/kiosk/advertisement may be configured as a temporary “pop up” which in one or more embodiments may be limited to a select number of users. This may create interest and excitement around new products or services and could be beneficial for a consumer, for celebrity fashion brands or for other retailers. When finished creating the advertisement/kiosk and/or store, the user may be provided the option to exit the main game 300 in which case the user will also exit the main game 300, otherwise the user may simply return to the main game 300.

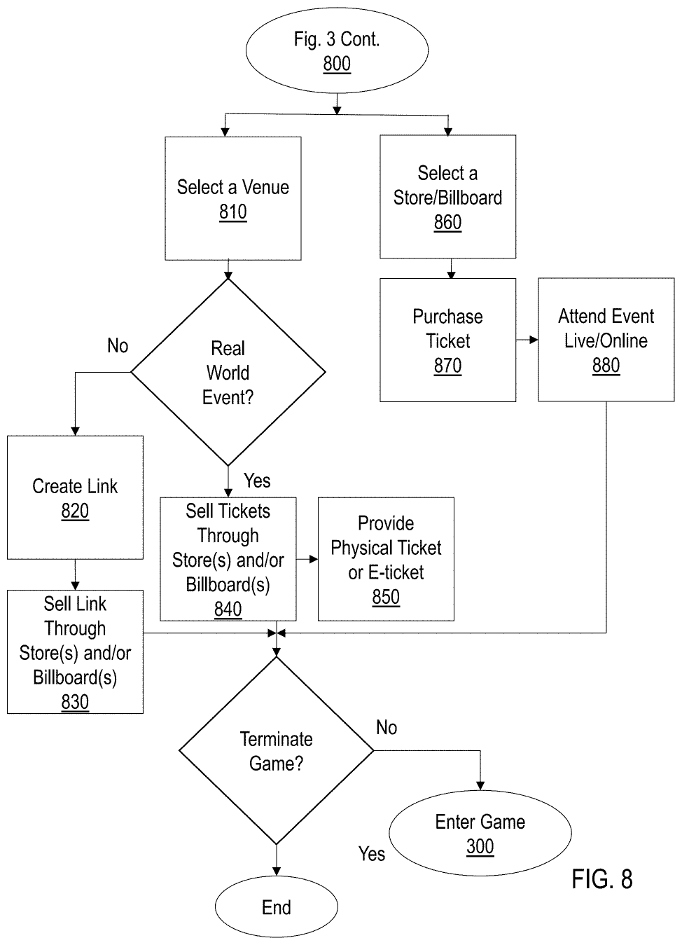

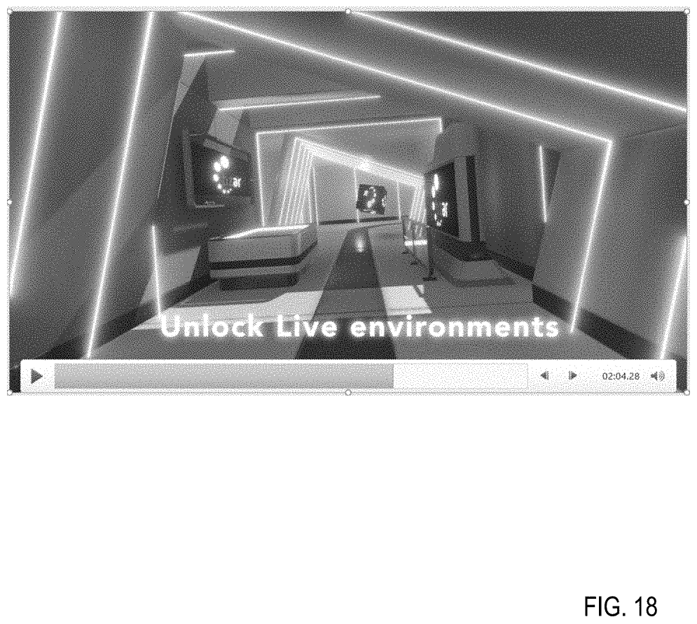

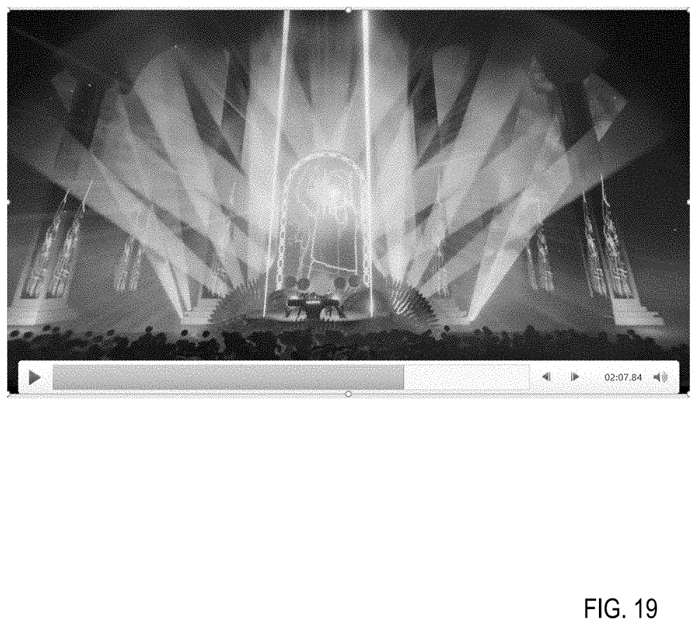

FIG. 8 and FIG. 22 illustrates when a user selects to create and/or attend an event 350/800 such as a concert. The event may be held in the game (e.g. attending a concert FIGS. 19 and 20) and/or in the real-world. If the user wishes to purchase entrance into the event, similar to the way that a user would purchase a product FIG. 5 or a service FIG. 6, the user may select a store, kiosk or billboard 860 and purchase a ticket, invite or link to the event 870. Additionally, the user may enter a venue within the game 300 (FIG. 18) and purchase entrance to an event currently taking place at that venue or scheduled to take place in the future. Once purchased the user may be provided a ticket that can be printed and taken to the real-world venue, a link to watch the event within the game, an e-ticket that the user can present at a real-world venue or a similar entrance voucher.

When a user wishes to create an event, they select a venue 810 and determine if the event will take place in the real-world and/or in the game. Regardless, the user may sell tickets 840 and/or links 830 through the venue, stores, kiosks and/or advertisements within the game 300 and as indicate above provide tickets, e-tickets and/or links 820 or any other suitable entry method for entrance to the event. When finished creating or attending the event the user may be provided the option to exit the main game 300 in which case the user will exit the main game 300, otherwise the user may simply return to the main game 300.

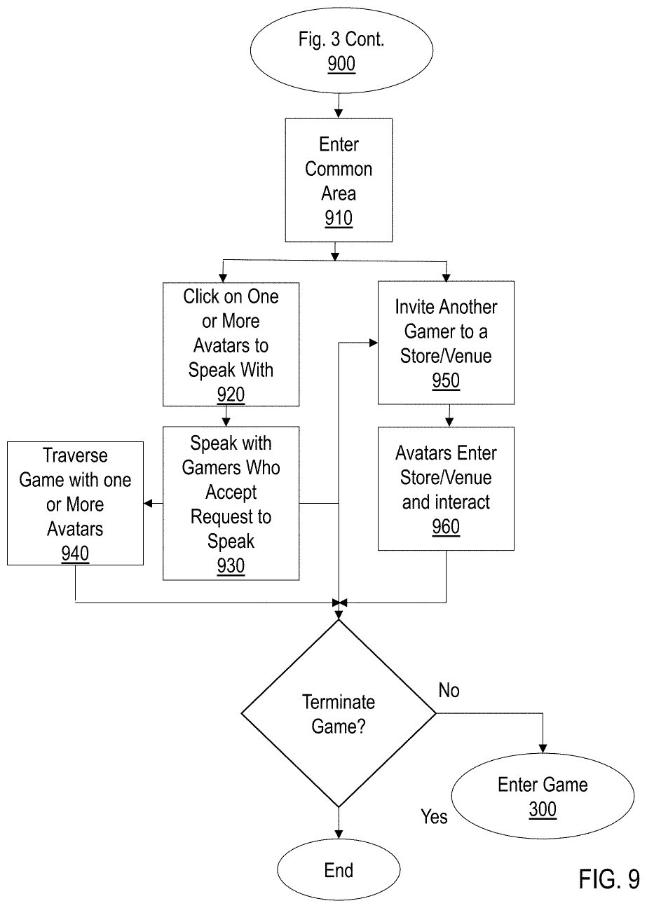

FIGS. 9 and 22 illustrate when a user enters the game 300 and decides to traverse the game and interact with other players 360/900. When the user enters the game 300 the user by default may be placed into a common area 900 or the user may enter a common area 910 from a private area. Typically, the common area will be inhabited by other users/players. A user may select one or more other users to speak with 920. If any of the selected users accepts the request, then all players who accepted may speak 930 with the user who requested the conversation. In one or more embodiments, the users may communicate using social platforms like Instagram™, Twitter™ TikTok™ and Facebook™ in a gaming/virtual retail environment which may be useful to both shoppers and retailers allowing for deeper social engagement with other shoppers and deeper, more meaningful relationships between brands and shoppers. Users may move around the game together 940 and/or they may make plans to meet at a particular location at a particular time. To that end, in one or more embodiments, users may provide invites and/or reminders to other players to meet at a destination and a time. Users may go shopping together and/or to events together if they have access to the same stores/events or if one user invites another user to the store/event. The users then may shop together as if in the real-world. A user may be provided with different modes of transportation. One or more of those modes may be free while one or more may require purchase or may need to be won or require performing one or more tasks. Any mode of transport may be provided based on a design choice of the game creator. At some point, one or more users may decide to terminate the game and or the relationship with another user. At that point that user may either exit the game 300 or merely reenter the game 300 and disconnect from the other user.

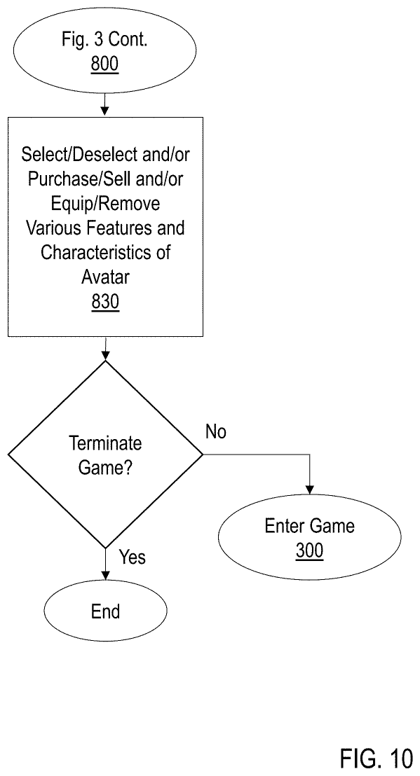

At some point during the game 300 a player may be assigned an avatar. The assignment may occur when the user signs up for the game or at any other point in the game that the host determines. The initial avatar my be a default avatar or it may be an avatar selected from a set of default avatars. At some point in the game, a user may wish to customize the avatar 800 FIGS. 10, 14 and 22. In one or more embodiments, the user may be provided the ability to customize the avatar at any point in the game. In one or more embodiments, the user may only be able to customize certain aspects of the avatar at any point in the game and may require visiting a store or performing some task to further customize the avatar. Additionally, or alternatively certain aspects of the avatar may require payment or invitations or winning a contest. In one or more embodiments, users may be able to trade various avatar features with other users. Examples of features which may be customizable and equipped or removed may include but are not limited to sex, hair color, hair length, hair style, eye color, mouth size, nose size, ear size, height, body type, clothing, makeup, jewelry, skin color, skin art, piercings, glasses, species, alien or any other feature that can make an avatar unique. Any one or more of these features may require payment or performance of a task or winning a contest. In one or more embodiments, a user may purchase items found exclusively in the game 300. In one or more embodiments, the avatar and/or items purchased in the game 300 may be used in other games such as but not limited to Fortnite™ In this manner, the user will stand out in other games because only those who shop and visit the game 300 will have a chance for those Avatar fashion items. Once the avatar is customized the user may terminate the game 300 in which case, the user will exit the game 300 or may rejoin the game 300.

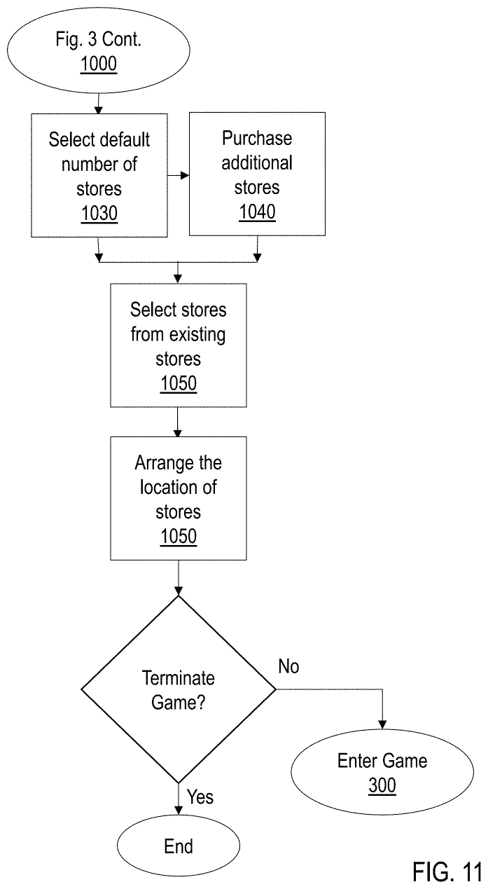

A user may be provided the ability to create their own mall environment/world 380/1000 (FIGS. 11 and 22). This mall environment includes the various stores/kiosks that the user will have access to when entering the game 300. Each user may be provided a set number of stores 1030 to choose from (e.g. select 25 retailers out of a large list). In one or more embodiments the number of stores is not limited while in one or more embodiments a user may purchase or win or perform one or more tasks to add 1040 additional stores to the mall. Once the stores are selected the mall may be automatically configured. In one or more embodiments, the user may be provided the option to customize various features of the mall (e.g. color schemes, building sizes, store front sizes, width of streets, covered, open air, one level, multiple levels, locations of stores etc.). When a user's avatar moves through public areas of their mall they may see and interact with other Avatars who happen to be in the public areas of their mall. Additionally, when a user enters a store in their mall, they user may see and interact with other users who have selected and entered the same store for their mall. This enables each user to have a unique experience within the game. In one or more embodiments, if a user in a common area wants another user to join them in a store, but that user does not have that store in their mall, the first user may invite the second user to the store, in which case the second user will be provided access or the second user may reconfigure their mall to include that store.

As illustrated in FIGS. 18 and 22, users may unlock areas of the game to participate in special events, private events, or other events. In one or more embodiments, an area may be unlocked through “easter eggs” in a shopping environment or though clues, such as but not limited to clues posted on billboards or within other advertisements, or by performing certain tasks such as inviting a certain number of friends to join the game, etc. Locked areas may include but not be limited to celebrity, influencer events or exclusive, private concerts hosted only in the game 300 and may only be attended by those that discover how to unlock that “world”. A world may be someone else's mall, or it may be a private venue or a link to another game.

In one or more embodiments, a user may win or purchase an opportunity to virtually meet and engage with celebrities and/or influencers either by exclusive invitation/promotion within the game or if the celebrity chooses to be in their pop up shop. Through the virtual world shopping/game Avatars can engage with the celebrities through real time speaking technology and have an Avatar+Avatar photo taken standing side by side or in various other poses in the virtual shopping worlds.

Having thus described one or more preferred embodiments of the technology, advantages can be appreciated. Variations from the described embodiments exist without departing from the scope of the technology. Thus, it is seen that combination online game and shopping mall systems and methods are provided. Although embodiments have been disclosed herein in detail, this has been done for purposes of illustration only, and is not intended to be limiting with respect to the scope of the claims, which follow.

In particular, it is contemplated that various substitutions, alterations, and modifications may be made without departing from the spirit and scope of the technology as defined by the claims. Other aspects, advantages, and modifications are considered within the scope of the following claims. The claims presented are representative of the technology disclosed herein. Other, unclaimed technology is also contemplated. The right to pursue such technology in later claims is hereby reserved.

Insofar as embodiments of the technology described above are implemented, at least in part, using a computer system, it will be appreciated that a computer program for implementing at least part of the described methods and/or the described systems is envisaged as an aspect of the technology. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example. The computer system may include a non-transitory computer-readable medium including one or more computer-executable instructions that, when executed by at least one processor of a computing device, cause the computing device to perform specified operations/functions.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the technology. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the technology which, as a matter of labuage, might be said to fall there between.

Having described the technology, what is claimed as a new and secured by Letters Patent is:

1. An improved e-commerce system comprising:
a game that is accessible via a network, wherein the game includes a representation of at least one physical world store; wherein the representation of the at least one physical world store offers at least one product or service to purchase from within the game; and,
wherein a purchase of a product from the representation of the at least one physical world store results in both the product being purchased and ownership of the product being transferred in the physical world; and,
wherein a purchase of a service from the representation of the at least one physical world store results in the service being performed in the real-world.

2. The e-commerce system according to claim 1 further including a representation of another store wherein the representation of the another store offers at least one in-game purchase of a product or service to be used within the game.

3. The e-commerce system according to claim 1 wherein the representation of the at least one physical store wherein the representation of the another store offers at least one in-game purchase of a product or service to be used within the game.

4. The e-commerce system according to claim 1 wherein the representation of the at least one physical world store is a representation of a plurality of physical world stores.

5. The e-commerce system according to claim 4 wherein the representation of the plurality of physical world stores is organized as a mall within the game, wherein the representation of the plurality of physical world stores within the mall is a subset of a larger group of potential representation of the plurality of physical world stores; and,
wherein at least two players of the game have malls with different subsets of the larger group of potential representation of the plurality of physical world stores.

6. The e-commerce system according to claim 1 wherein the representation of the at least one physical world store includes a store that is only available for a temporary time period.

7. The e-commerce system according to claim 1 wherein the representation of the at least one physical world store represents an event venue and the offer of at least one product or service to purchase from within the game includes an offer to purchase a ticket to an event or to purchase merchandise related to the event.

8. The e-commerce system according to claim 7 wherein the ticket provides access to a physical world venue.

9. The e-commerce system according to claim 8 wherein the ticket provides access to an in-game event.

10. The e-commerce system according to claim 4 further comprising an in-game payment system, wherein the in-game payment system may be used for purchases in at least two of the plurality of physical world stores within the game.

11. The e-commerce system according to claim 4 further including a shopping cart,
wherein selected purchases are placed into the shopping cart prior to payment and
wherein the selected purchases within the shopping cart may be paid for after leaving one or more of the plurality of stores.

12. The e-commerce system, according to claim 1 further including a customizable avatar that navigates the representation of the at least one physical world store.

13. A method for making physical world purchase within an online game, the method comprising:
providing a set of virtual stores within the online game, wherein the set of virtual stores is selectable by a gamer;
offering at least one product or service for purchase within at least one of the virtual stores; and,
providing the product or service in the physical world in response to the gamer making a purchase in the virtual store within the game.

14. The method according to claim 13 further including providing at least one hidden item that can only be purchased when a gamer performs a predetermined set of actions.

15. The method according to claim 13 further including providing at least one hidden store that can only be accessed when a gamer performs a predetermined set of actions.

16. The method according to claim 13 wherein the product is a ticket to an event and the event is held in a physical world venue.

17. The method according to claim 16 wherein the event is also held in a venue within the game.

18. The method according to claim 13 further including providing an avatar for the gamer to navigate the set of virtual stores.

19. The method according to claim 18 wherein the avatar interacts with other avatars within the game such that the gamer may speak with other gamers via the avatars.

20. The method according to claim 18 wherein the avatar interacts with other avatars within the game such that the gamer may invite other gamers, via the avatars, to navigate the game together.

21. The method according to claim 13 wherein the purchase is made with an in-game payment system.

22. The method according to claim 13 further providing at least one additional game within the online game.

23. The method according to claim 13 wherein the set of stores selected by the gamer is selected from a larger set of virtual stores available within the game.

24. A non-transitory computer-readable medium comprising one or more computer-executable instructions that, when executed by at least one processor of a computing device, cause the computing device to:
connect to a game via a network;
receive input to enter a virtual store within the game and make a purchase within the game that is effective in the physical world; and,
deliver payment for the purchase within the game.

25. The non-transitory computer-readable medium according to claim 24 further comprising one or more computer-executable instructions that cause the computing device to:
receive a selection of a plurality of stores to display within the game for a first gamer, wherein the selection is a subset of all available stores for display within the game, and
receive a selection of another plurality of stores to display within the game for another gamer, wherein the plurality of stores and the another plurality of stores differ by at least one store.

26. The non-transitory computer-readable medium according to claim 25 further comprising one or more computer-executable instructions that cause the computing device to create a mall within the game for the first gamer including only the selected plurality of stores, and create a mall within the game for the second gamer including only the selected another plurality of stores.

27. The non-transitory computer-readable medium according to claim 24 further comprising one or more computer-executable instructions that cause the computing device to provide an avatar for a first gamer, wherein the avatar is customizable by the first gamer, and provide another avatar for a second gamer, wherein the avatar is customizable by the first gamer.

28. The non-transitory computer-readable medium according to claim 24 further comprising one or more computer-executable instructions that cause the computing device to enable the first gamer to interact with the second gamer via the avatar and the another avatar.

29. The non-transitory computer-readable medium according to claim 24 further comprising one or more computer-executable instructions that cause the computing device to provide 3-dimensional game play.
